(19) United States
(12) Patent Application Publication
(10) Pub. No.: US 2008/0301798 A1
(43) Pub. Date: Dec. 4, 2008

(54) Apparatus and Method for Secure Updating of a Vulnerable System over a Network

(75) Inventors: Da Ming Hao, Beijing (CN); Wei Li, Beijing (CN); Lin Luo, Beijing (CN); Hang Jun Ye, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/016,320

(22) Filed: Jan. 18, 2008

(30) Foreign Application Priority Data
Jan. 18, 2007 (CN) 200710004248.5

(51) Int. Cl. G06F 9/00

(52) U.S. Cl. 726/13

(57) ABSTRACT

An apparatus interposed between a vulnerable system and a network for secure updating of the system includes an internal interface connected to the system; an external interface connected to the network; and one or more filter modules for filtering out specific incoming network packets to block possible network attacks. The filtering may comprise filtering out all incoming TCP SYN packets; filtering out all incoming TCP SYN packets and UDP packets; and/or only allowing packets pertinent to any outgoing connection initiated by the system.

### FIELD OF THE INVENTION

The present invention relates to the field of computer security, and in particular to an apparatus and method for secure updating of a vulnerable system over a network.

### BACKGROUND OF THE INVENTION

The security incidents caused by internet worms are becoming major threats to personal computers and enterprise IT systems. According to a report from CERT/CC, vulnerabilities reported in 2003 amounted to 3,784 and incidents reported in 2003 amounted to 137,529, with the numbers increasing rapidly. The famous “Blaster” worm prevalent in 2003 caused the crashing of millions of computer and incurred huge losses to individuals and enterprises.

Most vulnerabilities are caused by faulty software, and if malicious hackers exploit the vulnerability (reported or unreported) and spread a worm, a security incident will occur. For example, the “Blaster” worm exploits a vulnerability in Microsoft's DCOM RPC interface as described in Microsoft Security Bulletin MS03-026.

One of the most practical approaches to minimizing threats caused by internet worms is to keep your eyes on internet security reports and patch your system frequently to eliminate vulnerabilities present in the system. However, software systems are typically so extremely complex and there are so many reported vulnerabilities and required patches (e.g., dozens of, maybe hundreds of security patches from MS) that it is nearly impossible for a common user to download every required security update and patch it manually. Therefore many software vendors provide online updating systems, e.g. Microsoft Windows Update, Symantec Live Update, etc. In such a system, a special client software would determine which updates are required and download them from update sites automatically.

Live updating over a network has the advantage of good manageability but unfortunately, the vulnerable system is extremely likely to be attacked by worms when it is performing live updating over a network. Especially for a 0-day attack or a newly installed system, live updating might be a disaster. 0-day attack refers to the behavior of attack with a worm etc. at the same day when a security vulnerability is published by exploiting the security vulnerability. Since at this time there is not yet an update patch to the security vulnerability, when the system is performing a security update against other vulnerabilities, it has no defense against the 0-day attack. Further, a newly installed system which has not yet been patched with any security updates would be vulnerable to all reported security holes and worms. When it is connecting to a network to download updates, it is very likely to be infected by a worm before it completes updating. That is even true in an intranet of enterprise. “Worms that never die within the IBM network” has been listed as the second threat in IGA 2004 IT Threat Summit.

A remedy to this issue is to isolate the vulnerable system with a temporary firewall and make it invisible to all other machines when it is connecting to the network and downloading updates. Another possible approach is to manually download updates in an invulnerable system (e.g., a Linux box, or a Windows box that has been patched) and copy these updates by any means other than over network (USB disk, CDR, etc.). However, both approaches will cause a lot of inconvenience for users. The former requires reconfiguring the network or installing a firewall specifically used for online updating, and the latter loses the advantages of convenience and time-saving of automatic updating.

A pure software approach can also be contemplated, for example, a firewall module of the OS can be employed to filter out all special network packets possibly coming from worms. But this solution has difficulty to support legacy OSs, and it also increases the risk due to faulty implementation of this module or other OS modules.

Apparently, there exists a need for a more convenient and secure apparatus and method for secure updating of a vulnerable system over a network

### SUMMARY OF THE INVENTION

In the present invention, an inventive apparatus is utilized or activated when a vulnerable system is connecting to a network to download secure updates. This apparatus is interposed between the vulnerable system and the network, and will only allow outgoing connections from the system to the external network and disable incoming connections by filtering out special network packets (e.g., TCP SYN packets, or all UDP packets). It will block malicious network packets from worms and protect the vulnerable system from network attacking.

In an aspect of the present invention, there is provided an apparatus for secure updating of a vulnerable system over a network, the apparatus interposed between the system and the network and implemented as special hardware, and comprising: an internal interface connected to the system; an external interface connected to the network; and at least one filter module for filtering out special incoming packets to block possible network attacking.

In another aspect of the present invention, there is also provided a method for secure updating of a vulnerable system over a network, the method comprising the steps of: disposing said apparatus between the system and the network; and performing secure updating of the system over the network through the apparatus.

In yet another aspect of the present invention, there is further provided a method for secure updating of a vulnerable system over a network, the method comprising the steps of: the vulnerable system sending an updating request to an update server over the network to update; and filtering out special incoming network packets to prevent possible network attacking.

Compared with prior art solutions, the present invention has the following advantages:

In contrast to a pure software implementation (e.g., a firewall module of the OS), the apparatus of the present invention is independent of the OS, and thus reducing the end users' costs for supporting multiple operating systems and eliminating the risk due to faulty implementation of this module or other OS modules.

The apparatus of the present invention is transparent to users and software and thus very convenient. It does not require reconfiguring the network or installing a firewall specifically for online updating, and also avoids manually downloading updates from the network.

Since the filtering rules are simple, the apparatus can be implemented with very low cost.

### BRIEF DESCRIPTION OF THE DRAWINGS

The novel features believed characteristic of the present invention are set forth in the appended claims, the invention itself, however, as well as a preferred mode of use, further objects and advantages thereof, will best be understood by reference to the following detailed description of illustrative embodiments when read in conjunction with the accompanying drawings, it being understood, however, that the drawings only illustrate exemplary embodiments of the present invention, and are not intended to be limiting the scope of the present invention, wherein:

FIG. 1 is a schematic block diagram illustrating an apparatus for secure updating of a vulnerable system over a network according to an embodiment of the present invention; and

FIG. 2 is a schematic flow diagram illustrating a method for secure updating of a vulnerable system over a network according to an embodiment of the present invention.

### DETAILED DESCRIPTION OF THE INVENTION

In the following, embodiments of an apparatus for secure updating of a vulnerable system over a network of the present invention will be described in detail with reference to the drawings. It is to be noted that the following description is only for illustration and explanation purposes and is not intended to limit the present invention. Numerous technical details are set forth in the following description in order for those skilled in the art to be able to implement the present invention based thereon, but does not mean that these details are indispensable for implementation of the present invention. The present invention can be implemented without some of the features, or with additional or different features.

In the description, references to “one embodiment”, “a preferred embodiment”, “an embodiment” or similar language mean that the specific features, structures, or characteristics described in connection with the embodiment are contained in at least one embodiment of the present invention. Therefore, the phrases “an embodiment” or “a preferred embodiment” appearing throughout the description can, but does not necessarily, refer to the same embodiment. In addition, the described features, structures and characteristics of the present invention can be combined in one or more embodiments in any appropriate manner.

The apparatus for secure updating of a vulnerable system over a network of the present invention has two main embodiments. One embodiment is a standalone device interposed between the system and the network. The other embodiment is an embedded module physically present on the network interface card or other system component.

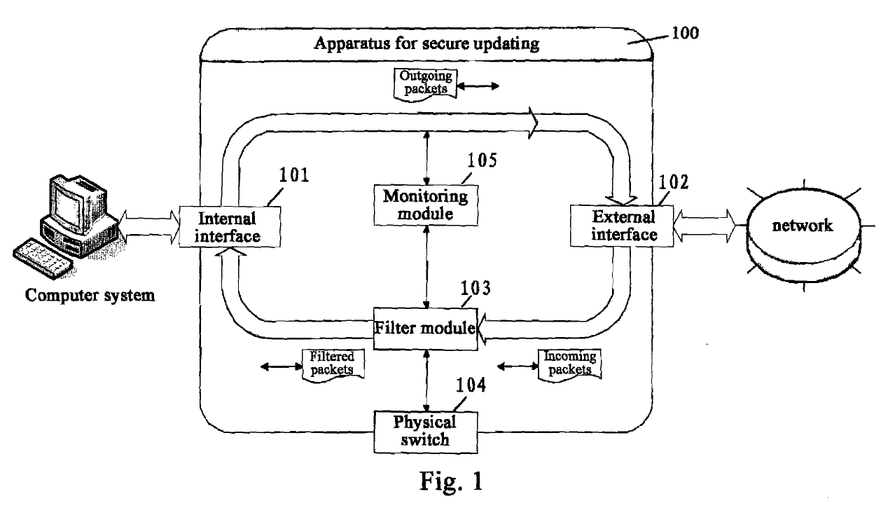

FIG. 1 is a schematic diagram illustrating an apparatus 100 for secure updating of a vulnerable system over a network. As shown, the apparatus 100 for secure updating of a vulnerable system is a standalone device interposed between the computer system to be updated and the network, and preferably located near the computer system to be updated. Alternatively, the apparatus 100 can also be located near a hub or another device connected with multiple computer systems, for secure updating of the multiple computer systems over the network. As another alternative, the apparatus can be interposed between an internal network and an external network, and be located near a network firewall, a proxy server, a gateway or another device, so that the apparatus 100 for secure updating of a vulnerable system over a network will be used for secure updating of multiple computer systems within the internal network.

As can be understood by those skilled in the art, the vulnerable system refers to any computer system or digital processing system that need to perform secure updating, including but not limited to a personal computer, workstation, application server, proxy server, gateway, router, etc. The network refers to any computer network, including but not limited to a LAN, WAN, intranet, Internet, wireless network, etc.

As shown, the apparatus 100 for secure updating of a vulnerable system over a network comprises an internal interface 101 connected to the computer system to be securely updated, an external interface 102 connected to the network, and at least one filter module 103 which can block possible network attacks by filtering out special network packets.

The apparatus 100 as a standalone device can be implemented as a plug-socket pair (similar to an adapter) interposed between the network interface card of the vulnerable computer system to be updated and the cable, or can be implemented as a special network cable, thus facilitating the connection of the apparatus and the computer system and its use. Of course, the present invention is not limited thereto.

When the apparatus 100 of the present invention is implemented as a plug-socket pair, the internal interface 101 is connected with the network interface card of the computer system to be securely updated, and the external interface 102 is connected with the insecure external network. The hardware form of the internal interface 101 can be, for example, a RJ45-type network cable plug, and the hardware form of the external interface 102 can be, for example, a RJ45-type network cable socket. Of course, other forms of plug and socket can also be adopted.

When the apparatus 100 of the present invention is implemented as a special cable, the internal interface 101 is connected with the network interface card of the computer system to be securely updated, and the external interface 102 is connected with the external network. The hardware form of both the internal interface 101 and the external interface 102 can be, for example, a RJ45-type network cable plug. Of course, other forms of network plug can also be adopted.

It is to be noted that in a preferred embodiment of the present invention, the internal interface 101 and the external interface 102 are only simple hardware connection device for connecting the apparatus 100 of the present invention to the computer system to be securely updated and the external network so that data packets can be exchanged between the computer system to be securely updated and the external network through the apparatus 100 of the present invention, and they do not process the data packets passing through the apparatus 100 of the present invention in any way by themselves. Therefore, the internal interface 101 and the external interface 102 can be of any standard or non-standard hardware connection form. Of course, the internal interface 101 and the external interface 102 can also have some data processing functions such as data buffering by themselves, in which case they can be more complex functional modules with certain hardware or software constructions.

Outgoing packets in connection with requests for secure updating from the computer system to be securely updated are passed into the apparatus 100 of the present invention through the internal interface 100, and passed out to the external network over the external interface 102, and then passed to the corresponding secure update server through the external network. And data packets containing secure updating data from the secure update server and any other incoming data packets are passed into the apparatus 100 of the present invention through the external network 102, and processed by the filter module 103 according to the present invention. Accordingly, possibly malicious special data packets are filtered out and data packets containing the secure updating data from the secure update server are permitted to pass. Then, the filtered data packets containing the secure updating data are passed to the vulnerable computer system to be securely updated through the internal interface 101.

The filter module 103 can be configured to filter out all incoming TCP SYN packets to prohibit all incoming connections. This will prevent network attacks that need to establish a TCP connection to the computer system, and since most network attacks need to first establish a connection to the computer system by a TCP SYN packet, this will prevent the majority of network attacks.

The filter module 103 can also be configured to filter out all incoming UDP packets to prevent network attacks to UDP services.

Since most worms attack by TCP or UDP ports, filtering out both TCP SYN and UDP packets can prevent the majority of network worm attacks.

As can be understood by those skilled in the art, the filter module 103 can determine whether a TCP packet is a TCP SYN packet by analyzing the SYN bit in a header of the TCP message segment, and can determine whether the packet is a TCP packet or a UDP packet by analyzing the “protocol” field in a header of the IP datagram.

The filter module 103 can be implemented either as an ASIC chip, or as firmware. Considering the cost and performance problem, the filter module 103 is preferably implemented as an ASIC chip.

Preferably, the apparatus 100 for secure updating of a vulnerable system over a network of the present invention further comprises a physical switch 104 for controlling the filtering levels of the filter module 103, the filtering levels comprising, for example, only filtering out TCP SYN packets, or filtering out TCP SYN packets and all UDP packets.

Preferably, the apparatus 100 for secure updating of a vulnerable system over a network further comprises a monitoring module 105 for monitoring all outgoing connections initiated by the protected computer system, that is, monitoring all the outgoing packets passed from the internal interface 101 to the external interface 102. When the monitoring module 105 detects a TCP SYN packet sent from the protected computer system, it will record the destination address and destination port, and inform the filter module 103 either by active informing or by waiting for the filter module 103 to query. Thereafter, when the filter module 103 receives incoming TCP packets, it will detect the source address and source port of the TCP packet, and only allow those packets consistent with the recorded destination address and destination port to pass. Correspondingly, the filtering levels of the filter module 103 as controlled by the physical switch 104 further comprise filtering out all incoming packet not pertinent to any outgoing connection, and only allowing packets pertinent to an outgoing connection initiated by the protected computer system to enter the computer system. In addition, the monitoring module 105 can be configured to monitor and record the outgoing connections pertinent to one or more secure updates, so that the filter module 103 will only allow the packets pertinent to the one or more secure updates to pass, for example, by limiting the source IP addresses or ports of incoming packets to be the recorded destination addresses and destination ports of the outgoing TCP SYN packets pertinent to the secure updates.

Preferably, the apparatus 100 for secure updating of a vulnerable system over a network can be activated/deactivated through a physical presence evidence, such as a position of a physical switch, etc. In contrast to pure software options, a physical presence evidence can ensure that the apparatus can be activated without any possibly faulty software being exposed to attacks from the network, and that no software can tamper with the apparatus. The physical switch for activating/deactivating the apparatus 100 can either use the above described physical switch 104 for controlling the filtering levels of the filtering monitoring module 103, in which case the position of the physical switch 104 will be used for activating/deactivating the apparatus 100, or be a physical switch specifically used for activating/deactivating the apparatus 100.

When a vulnerable system protected by the apparatus 100 of the present invention will be securely updated over a network, the apparatus 100 of the present invention can be activated/deactivated through the physical presence evidence, so as to allow the data packets containing secure update data from the secure update server to enter the protected vulnerable system through the apparatus 100 to perform the secure update, while the vulnerable system will be prevented temporarily from providing services to the external network. Upon completing the secure update, the apparatus 100 of the present invention can be deactivated through the physical presence evidence, so that data packets can be passed as normal between the protected computer system and the external network through the apparatus 100 of the present invention, and the protected system can provide services to the external network or perform other kinds of data exchange.

The physical switch 104 can be a multi-position switch, which has multiple positions for controlling whether to perform filtering and the filtering levels. For example, position 0—no filtering; position 1—only filtering out TCP SYN packets; position 2—filtering out both TCP SYN packets and UDP packets; position 3—filtering out TCP SYN packets and UDA packets and only allow packets pertinent to any outgoing connection initiated by the system. Preferably, the physical switch 104 is operated manually. The filter module 103 can select a filtering level by reading the status of the physical switch 104.

While in the foregoing the embodiment of the apparatus 100 for secure updating of a vulnerable system over a network of the present invention as a standalone device has been described, the apparatus 100 for secure updating of a vulnerable system over a network of the present invention can also be implemented as an embedded module in a network interface card or another computer component. When the apparatus 100 of the present invention is implemented as an embedded module in a network interface card or another computer component, its internal structure is similar to the embodiment of the apparatus 100 of the present invention as a standalone device. In the following, only the differences between the embodiment of the apparatus 100 of the present invention as an embedded module in a network interface card and the above embodiment of the apparatus 100 as a standalone device will be described, where the same parts therebetween will be omitted.

When the apparatus 100 of the present invention is implemented as an embedded module of a network interface card, the internal interface 101 is connected with the external interface of the original network interface card, and the external interface 102 is connected with the insecure external network. The hardware forms of the internal interface 101 and the external interface 102 are both chip pins.

The physical presence evidence for activating/deactivating the apparatus 100 of the present invention can be either a position of a physical switch, or an option in the BIOS settings.

In another aspect of the present invention, there is also provided a method for secure updating of a vulnerable system over a network, the method comprising the following steps: providing the above described apparatus for secure updating of a vulnerable system over a network of the present invention between the system and the network; and performing secure updating of the system over the network through the apparatus.

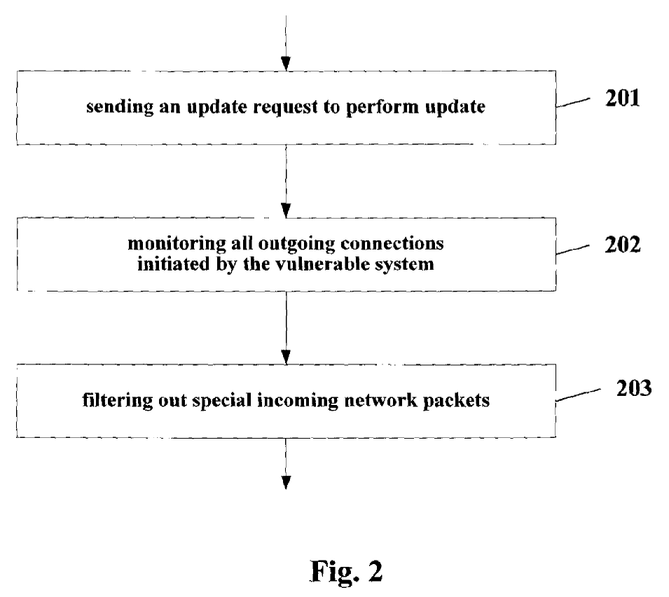

In yet another aspect of the present invention, there is also provided a method for secure updating of a vulnerable system over a network. FIG. 2 illustrates the method for secure updating of a vulnerable system over a network. As shown, the method comprises the following steps: in step 201, the vulnerable system sends an update request to an update server in order to perform updating. In step 203, special incoming network packets are filtered out in order to block possible network attacks. The filtering step preferably can filter out all incoming TCP SYN packets, or can filter out all incoming TCP SYN packets and all incoming UDP packets.

Preferably, the method further comprises step 202, where all outgoing connections initiated by the system are monitored; and in this case, the filtering step 203 can comprise only allowing the packets pertinent to any monitored outgoing connection initiated by the vulnerable system to enter the system. Preferably, the filter module 203 can further be set to only allow packets pertinent to a specific secure update to enter the system.

Preferably, the method is performed by special hardware, such as a plug-socket pair between a network interface card and a cable, a special network cable, an embedded module in a network interface card, etc. Of course, the method can also be performed by a combination of computer software and general-purpose computer hardware.

In the foregoing, the apparatus and method for secure updating of a vulnerable system over a network according to embodiments of the present invention have been described, it being understood by those skilled in the art that the apparatus and method can be modified in various ways without departing from the basic spirit and scope of the present invention. For example, in the apparatus of the present invention, new modules may be added, existing modules may be modified, combined or further split into smaller modules, some modules may be removed, and the linking relationships between modules can be altered, etc., and in the method of the present invention, new steps may be added, existing steps may be combined, some modules may be further split, some modules may be removed, the execution order between some steps may be altered, etc., and all these variations are within the scope of the present invention, which is defined by the appended claims.

1. An apparatus for secure updating of a vulnerable system over a network, the apparatus interposed between the system and the network, and implemented as a special hardware, the apparatus comprising:
an internal interface connected to the system;
an external interface connected to the network; and
at least one filter module for filtering out specific incoming network packets to block possible network attacks.

2. The apparatus according to claim 1, further comprising a physical switch for controlling filtering levels of the at least one filter module.

3. The apparatus according to claim 1, further comprising a monitoring module for monitoring outgoing connections initiated by the system.

4. The apparatus according to claim 2, wherein the filtering levels comprise:
filtering out all incoming TCP SYN packets; and
filtering out all incoming TCP SYN packets and all incoming UDP packets.

5. The apparatus according to claim 3, wherein the filtering levels comprise:
filtering out all incoming TCP SYN packets;
filtering out all incoming TCP SYN packets and all incoming UDP packets; and
only allowing packets pertinent to any outgoing connection initiated by the system as monitored by the monitoring module to enter the system.

6. The apparatus according to claim 5, wherein the filtering levels further comprise:
only allowing packets pertinent to a specific secure update to enter the system.

7. The apparatus according to any of claim 1, wherein the apparatus can be activated/deactivated by using physical presence indicator.

8. The apparatus according to claim 7, wherein the physical presence indicator is at least one of a position of a physical switch and an option in BIOS settings.

9. The apparatus according to claim 1, wherein the at least one filter module comprises at least one ASIC chip.

10. The apparatus according to claim 1, wherein the at least one filter module comprises firmware.

11. The apparatus according to claim 1, wherein the apparatus is a standalone device.

12. The apparatus according to claim 11, wherein the standalone device comprises a plug-socket pair interposed between a network interface card and a cable.

13. The apparatus according to claim 11, wherein the standalone device comprises a special network cable.

14. The apparatus according to claim 1, wherein the apparatus is an embedded module in a network interface card.

15. The apparatus according to claim 11, wherein the apparatus is located near the vulnerable system.

16. The apparatus according to claim 11, wherein the apparatus is located near a gateway for multiple vulnerable systems.

17. A method for secure updating of a vulnerable system over a network, comprising the steps of:
providing an apparatus between the system and the network comprising:
an internal interface connected to the system;
an external interface connected to the network; and
at least one filter module for filtering out specific incoming network packets to block possible network attacks; and
performing secure updating of the system over the network through the apparatus.

18. A method for secure updating of a vulnerable system over a network, comprising the steps of:
the vulnerable system sending an update request to an update server over the network to perform update; and
filtering out special incoming network packets to block any possible network attack.

19. The method according to claim 18, wherein the method is performed by any one of a plug-socket pair, a special network cable, and an embedded module in a network interface card.

20. The apparatus according to claim 19, wherein the filtering step comprises filtering out all incoming TCP SYN packets.

21. The apparatus according to claim 19 or 20, wherein the filtering step further comprises filtering out all incoming UDP packets.

22. The apparatus according to claim 19, further comprises the step of monitoring all outgoing connections initiated by the vulnerable system; and the filtering step comprises only allowing packets pertinent to any monitored outgoing connection initiated by the vulnerable system to enter the system.

23. The apparatus according to claim 22, wherein the filtering step further comprises only allowing packets pertinent to a specific secure update to enter the system.
